(19) United States
(12) Patent Application Publication
(10) Pub. No.: US 2008/0092705 A1
(43) Pub. Date: Apr. 24, 2008

(54) FLATBED DIECUTTING MACHINE

(75) Inventors: Thomas Imkamp, Dusseldorf (DE); Peter Palmen, Monchengladbach (DE); Frank Schmid, Krefeld (DE)

Correspondence Address: HEIDELBERGER DRUCKSMASCHINEN AKTIENGESELISCHAFT;C/O KEATING & BENNETT, LLP, 8180 GREENSBORO DRIVE, SUITE 850, MCLEAN, VA, 22102, US

(73) Assignee: HEIDELBERGER DRUCKMASCHINEN AKTIENGESELLSCHAFT, Heidelberg (DE)

(21) Appl. No.: 11/873,267

(22) Filed: Oct. 16, 2007

(30) Foreign Application Priority Data
Oct. 18, 2006 (DE) 10 2006 049 111.4

(51) Int. Cl. B26F 1/38; B26D 7/06

(52) U.S. Cl. 83/155; 100/102

(57) ABSTRACT

A flat-bed diecutting machine for cutting and/or stamping and/or embossing sheets, the flat-bed diecutting machine includes a first diecutting device, a conveying device including a drive and arranged to transport the sheets to be processed through the first diecutting device, and at least one second diecutting device provided downstream of the first diecutting device so as to make it possible to process sheets that require very high cutting forces in one pass and to reduce set-up or changeover times.

### BACKGROUND OF THE INVENTION

1. Field of the Invention

The present invention relates to a flatbed diecutting machine for diecutting and/or embossing sheet-like materials made of paper, paperboard, or the like, in particular for producing paper or paperboard blanks, including a diecutting device and a transport device for transporting the sheets of material to be processed through the diecutting device.

2. Description of the Related Art

Diecutting refers to the process of cutting closed geometric blank shapes that may be circular, oval, polygonal, or have any desired shape. Print finishing processes such as punching with hollow punches, corner cutting, and index cutting also belong to this field. The diecutting is carried out against a cutting pad or stamps. In some cases, a shearing process is used (cf. Druckweiterverarbeitung, Ausbildungsleitfaden für Buchbinder, Bundesverband Druck e.V. 1996, pages 351ff.) [Print Finishing, Training Guide for Bookbinders].

Packaging materials made of paper, paperboard, cardboard or corrugated paperboard are mainly cut from sheets. It is also possible to introduce crease lines or blind embossing into blanks in a diecutting operation. This complex process requires that the sheets be processed individually. As the finished products are sophisticated packaging that is highly complex in terms of technical and graphic design (for example, for cosmetics, cigarettes, pharmaceuticals, food, etc.), it is not only necessary to use high-quality materials that meet specific requirements, but also to use diecutting tools with very low tolerances and diecutting machines that work with great accuracy and reliability in order to achieve optimum results.

Flatbed diecutting is a process that best meets these requirements. In diecutting, printed sheets that have been stacked in a pile on a pallet are fed to the diecutting machine. In the machine, the sheets to be cut are separated in a separating device and, having been brought into precise alignment in an alignment device, are subsequently transferred to a gripper carriage, which positions the sheets accurately in the diecutting device, between a stationary lower table and an upper table that is vertically movable via a toggle lever transmission or eccentric transmission. Such a flatbed diecutting machine is known, for example, from DE 30 44 083 A1. Alternatively, diecutters are known wherein the upper table is stationary and the lower table is vertically movable.

The two tables are equipped with cutting and creasing tools and corresponding counterpressure tools for cutting the blanks out of the sheets that are cyclically fed between the table surfaces and for creating the crease lines that are required for accurate folds. In the subsequent stripping device, stripping tools automatically remove the waste. Depending on the equipment of the machine, the cut blanks may finally be separated in a blank separating device provided for this purpose.

The known flatbed diecutting machines, offered, for example, by the applicant under the brand name Dymatrix, have a central drive. On the one hand, the central drive drives a transport device for transporting the sheets to be processed through the machine, and on the other hand, the central drive drives the individual processing stations by means of a push rod transmission. A problem connected to driving the upper table of the diecutting device by means of such a push rod transmission is that the push rods can only be used to adjust the distance that the upper table has to travel but not to adjust the cutting force and cutting speed. This is a disadvantage inasmuch as higher cutting forces are required when many small blanks are to be cut from a sheet than when only one blank is to be cut from a sheet. So far, the problem has been solved by moving the sheet multiple times through the diecutting machine when many small blanks are to be cut. However, this is a rather time-consuming solution. In addition, the preparation of the tools is a complicated process if, for example, creasing and cutting are to be done in one pass.

### SUMMARY OF THE INVENTION

In order to solve the problems described above, preferred embodiments of the present invention provide a flatbed diecutting machine that makes it possible to process sheets that require very high cutting forces in one pass and that achieves reduced set-up or changeover times.

According to a preferred embodiment of the present invention, a flatbed diecutting machine includes a diecutting device and at least one further diecutting device downstream of the diecutting device. Due to the fact that the diecutting machine according to a preferred embodiment of the present invention includes at least two cutting devices arranged in line, i.e., behind each other, it is capable of completing the processing of sheets of material in one pass that so far needed to be passed through the diecutting machine multiple times. Moreover, the operations of diecutting and creasing may be carried out in two work stations, a fact which would reduce set-up times to a considerable extent. For this purpose, the second diecutting station is preferably designed as a creasing station.

In addition, a foil may be stamped onto a sheet in the first diecutting device, and to carry-out an embossing and/or diecutting operation in the second diecutting device. Thus, the diecutting machine according to a preferred embodiment of the present invention is even suited for carrying out complex processing operations in one pass.

In a preferred embodiment of the present invention, each of the individual processing stations is designed as an independent module with its own drive. As a result, the different cutting stations can operate with cutting forces of different strength.

In an embodiment that is particularly preferred, each of the drives preferably includes a control unit. The control units are connected by a data and/or control signal exchange connection so as to provide easy communication.

Other features, elements, processes, steps, characteristics and advantages of the present invention will become more apparent from the following detailed description of preferred embodiments of the present invention with reference to the attached drawings.

### BRIEF DESCRIPTION OF DRAWINGS

The FIGURE illustrates a flat-bed diecutting machine according to a preferred embodiment of the present invention.

### DETAILED DESCRIPTION OF PREFERRED EMBODIMENTS

The flat-bed diecutting machine shown in the FIGURE is used to process sheet-like material made of paper, paperboard, and the like, by carrying out diecutting and/or stamping or embossing operations, in particular to produce paper or paperboard blanks. Arranged in line, i.e. behind each other, in the direction of sheet travel X, the machine includes a feeding and separating device 1, an alignment device 2, a diecutting device 3, a further diecutting device 3′, which may also be designed as a creasing, stamping, or embossing device, a stripping device 4, a blank depositing device 5, and a separation-sheet feeding device 6. In addition, a pallet station 7 is provided at the blank depositing device 5.

In the feeding and separating device 1, the sheets to be processed are made available in the shape of a pile and are removed from the pile individually from the top by using a suction head 8. The sheets are deposited on a conveyor belt 9, which feeds the sheet to the alignment device 2, where it is accurately aligned, for example, at three locations, through the use of side and front lays.

Having been aligned in the alignment station 2, the sheet is gripped by a gripper of a conveying system. In the drawing, only the conveyor chain 10 of the transport system is shown. The transport system guides the sheets through the remaining processing stations 3, 3′, 4, 5, 6 in a pulsed way and in accurate alignment.

The alignment device 2 is followed by the diecutting device 3. The diecutting device 3 preferably includes a lower table 11, which is firmly supported on the machine frame G, and an upper table 12, which is movable in the vertical direction. The upper table 12 carries a diecutting knife, and the lower table carries a counterpressure plate.

The upper table 12 is actuated in a known way preferably via an eccentric transmission 14, which is connected to the central drive of the diecutting machine. This central drive also drives the other processing stations.

The diecutting device 3 is followed by a further, second diecutting device 3′, which may also be designed as a creasing, stamping, or embossing device. In the example shown in the FIGURE, the second diecutting device preferably has substantially the same construction as the first diecutting device 3. However, it may be of different design.

The second diecutting device 3′ is followed by the stripping device 4, wherein the non-usable pieces of waste that have been created in the diecutting processes are pushed downward and removed from the sheets. The waste pieces fall into a container-like carriage 15 that has been inserted below the stripping device 4.

The stripping device 4 is followed by the depositing device 5, wherein the sheet may either simply be deposited, or wherein the individual blanks may be separated from each other. For this purpose, any suitable separating tools may be used, which are not illustrated in any detail in the drawing. The sheets may be deposited and stacked on pallets that are located in the pallet station 7. Once a pile has reached a predetermined height, the pallet with the stack of piles may be removed from the region of the diecutting machine.

Due to the fact that the diecutting device includes at least two in-line diecutting devices 3, 3′, in one pass through the diecutting machine, the latter is capable of completing the processing of sheets of material of a type that so far would have had to be fed through the machine multiple times. For example, when many blanks are to be cut out of a sheet, these blanks may be pre-cut in the first diecutting device 3, and the cutting may then be completed in the second diecutting device 3′. In this case, the two diecutting devices 3, 3′ may be equipped with tools in an identical manner.

Moreover, the first diecutting device 3 may be used to stamp a foil onto a sheet. The second diecutting device 3′ may then be used to carry out an embossing and/or diecutting operation on the sheet that has been provided with a foil. If the diecutting devices 3, 3′ are equipped in a suitable way, the diecutting machine according to a preferred embodiment of the present invention may be used to carry out complex processing operations in one pass through the machine.

The individual processing stations 1, 2, 3, 3′, 4, 5, 6, 10 of the flat-bed diecutting machine may be designed as independent modules. As a result of such a modular design, the stations can be used in a particularly flexible way. For this purpose, each of the stations is preferably equipped with its own (non-illustrated) drive. For the purpose of further increasing flexibility, each of the drives may include a (non-illustrated) control unit. The individual control units may be connected to each other by a connection for exchanging data and/or control signals.

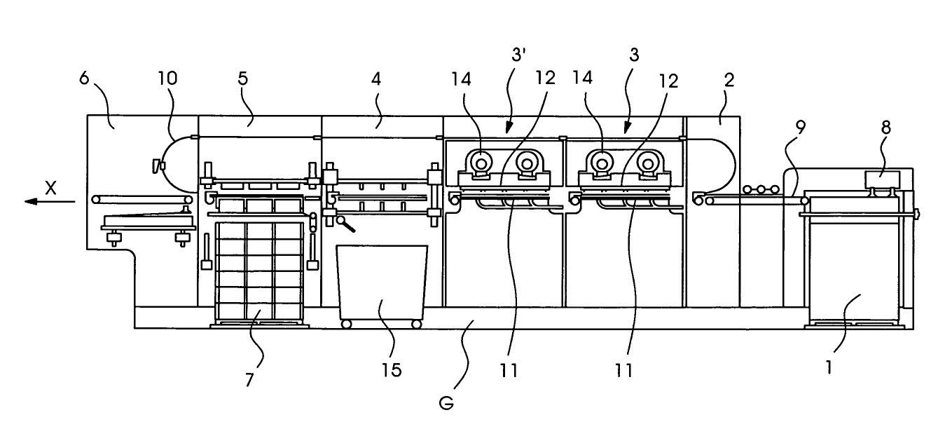

In the exemplary preferred embodiment shown in FIG. 1, the two diecutting stations are shown to directly follow each other. However, there may also be more than two diecutting stations. Although the diecutting stations may be arranged to directly follow each other, such an arrangement is not mandatory.

Moreover, the diecutting device may be equipped with further stripping devices. An advantage of such an arrangement would be that the force of the stripping tools could be reduced whenever critical values are reached.

In addition, it is possible to provide further blank depositing devices. These may, for example, be used as removal stations or for the purpose of taking samples.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A flat-bed diecutting machine for cutting and/or stamping and/or embossing sheets, the flat-bed diecutting machine comprising:
a first diecutting device;
at least one second diecutting device provided downstream of the first diecutting device; and
a conveying device including a drive and arranged to transport the sheets to be processed through the first and second diecutting devices.

2. The flat-bed diecutting machine as set forth in claim 1, wherein the first diecutting device is equipped to stamp a foil onto a sheet and the second diecutting device is equipped to carry out embossing and/or cutting operations on the sheet that has been provided with a foil.

3. The flat-bed diecutting machine as set forth in claim 1, wherein the first diecutting device is a diecutting device and the second diecutting device is a creasing device.

4. The flat-bed diecutting machine as set forth in claim 1, wherein each of the first diecutting device, the second diecutting device and other individual processing stations are independent modules each having its own drive.

5. The flat-bed diecutting machine as set forth in claim 4, wherein each of the drives includes a control unit and the individual control units are connected to each other by a connection for exchanging data and/or control signals.
